(19) United States
(12) Patent Application Publication
(10) Pub. No.: US 2016/0006033 A1
(43) Pub. Date: Jan. 7, 2016

(54) LITHIUM BATTERY

(71) Applicant: SAMSUNG SDI CO., LTD., Yongin-si (KR)

(72) Inventor: Kyeuyoon Sheem, Yongin-si (KR)

(21) Appl. No.: 14/792,475

(22) Filed: Jul. 6, 2015

(30) Foreign Application Priority Data
Jul. 7, 2014 (KR) 10-2014-0084626

(51) Int. Cl. H01M 4/58; H01M 4/36; H01M 10/052; H01M 4/583

(52) U.S. Cl. CPC H01M 4/581; H01M 4/583; H01M 4/366; H01M 4/5825; H01M 4/5815; H01M 10/052; H01M 2220/20

(57) ABSTRACT

A lithium battery includes a cathode, an anode, and a separator between the cathode and the anode. The cathode includes a first cathode active material layer including a first cathode active material on a first side of a cathode current collector and a second cathode active material layer including a second cathode active material on a second side of the cathode current collector opposite the first side. The anode includes a first anode active material layer including a first anode active material on a first side of an anode current collector and a second anode active material layer including a second anode active material on a second side of the anode current collector opposite the first side. At least one of the first cathode active material layer and the second cathode active material layer includes an ionically polarizable electrode material.

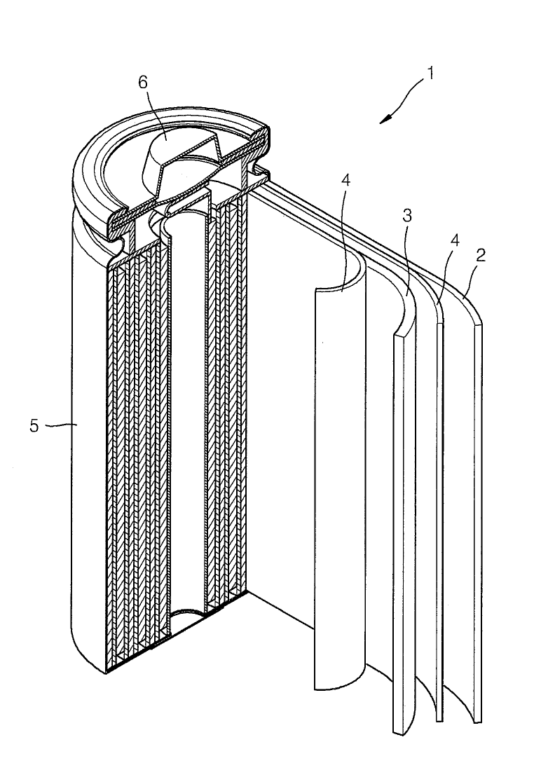

### CROSS-REFERENCE TO RELATED APPLICATION

This application claims priority to and the benefit of Korean Patent Application No. 10-2014-0084626, filed on Jul. 7, 2014, in the Korean Intellectual Property Office, the entire content of which is incorporated herein by reference.

### BACKGROUND

1. Field

One or more aspects of embodiments of the present invention relate to lithium batteries.

2. Description of the Related Art

Increase in demand for compact high performance devices has facilitated research efforts aimed at increasing the energy density of the lithium batteries, while also decreasing their size and weight. In other words, the demand for lithium batteries having high stability and improved lifetime characteristics, in addition to having a high capacity, has increased.

While certain lithium batteries can have high energy densities per unit weight or unit volume, these batteries may also suffer from low output densities. On the other hand, electrochemical capacitors, while having high output densities may suffer from low energy densities. Some electrochemical capacitors, such as, for example, super capacitors, have specific capacitance characteristics which are as much as 1,000 times higher than the specific capacitance characteristics of electrostatic capacitors.

Accordingly, some attempts have been made to realize energy storage devices having both high energy densities and high output densities by combining high energy densities of the lithium batteries with high output densities of super capacitors.

However, when the lithium batteries and the super capacitors are connected to each other in series or in parallel to form an energy storage device, internal resistance of such energy storage device may increase, or the lithium battery and/or the super capacitor in the energy storage device may deteriorate prematurely such that the overall performance of the energy storage device may decrease, and the energy storage device may become impractical.

SUMMARY

One or more aspects of embodiments of the present invention are directed toward lithium batteries having improved output characteristics and lifetime characteristics.

Additional aspects will be set forth in part in the description which follows and, in part, will be apparent from the description, or may be learned by practice of the presented embodiments.

According to one or more embodiments of the present invention, a lithium battery includes a cathode, an anode, and a separator between the cathode and the anode, wherein the cathode includes a first cathode active material layer including a first cathode active material on a first side of a cathode current collector and a second cathode active material layer including a second cathode active material on a second side of the cathode current collector opposite the first side, wherein the anode includes a first anode active material layer including a first anode active material on a first side of an anode current collector and a second anode active material layer including a second anode active material on a second side of the anode current collector opposite the first side, and wherein at least one of the first cathode active material layer and the second cathode active material layer includes an ionically polarizable electrode material.

A lithium battery having improved discharge capacity, output densities and lifetime characteristics can be realized.

### BRIEF DESCRIPTION OF THE DRAWINGS

These and/or other aspects will become apparent and more readily appreciated from the following description of the embodiments, taken in conjunction with the accompanying drawing, which illustrates a schematic perspective view of a lithium battery according to one or more embodiments of the present invention.

### DETAILED DESCRIPTION

Reference will now be made in detail to embodiments, examples of which are illustrated in the accompanying drawing, wherein like reference numerals refer to like elements throughout. As those skilled in the art would recognize, the present embodiments may have different forms and should not be construed as being limited to the descriptions set forth herein. Accordingly, the embodiments are merely described below, by referring to the drawing, to explain aspects of the present description. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the present invention refers to “one or more embodiments of the present invention.” In addition, as used herein, the terms “use,” “using,” and “used” may be considered synonymous with the terms “utilize,” “utilizing,” and “utilized,” respectively. Also, the term “substantially” is used herein as a term of approximation and not as a term of degree, and is intended to account for inherent deviations in measured or calculated values, as would be recognized by those of ordinary skill in the art.

Hereinafter, lithium batteries according to one or more embodiments of the present invention will be described.

A lithium battery according to one embodiment of the present invention includes a cathode, an anode, and a separator between the cathode and the anode. The cathode includes a first cathode active material layer including a first cathode active material on one side of a cathode current collector and a second cathode active material layer including a second cathode active material on the other side of the cathode current collector. Similarly, the anode includes a first anode active material layer including a first anode active material on one side of an anode current collector and a second anode active material layer including a second anode active material on the other side of the anode current collector. In some embodiments, at least one of the first cathode active material layer and the second cathode active material layer includes an ionically polarizable electrode material.

By positioning one electrode active material layer having a high discharge capacity on one side of a double-sided electrode, and positioning another electrode active material layer having high output characteristics on the other side of the double-sided electrode, the resulting lithium battery including an ionically polarizable material may have improved discharge capacity, output characteristics, and lifetime characteristics, while also suppressing an increase in internal resistance.

A related art double-sided electrode has the same electrode active material symmetrically formed on each side of the double-sided electrode. Such symmetrical formation of the related art double-sided electrode may enable a homogeneous electric current distribution at high output. That is, if the double-sided electrode has the same electrode active material asymmetrically formed on each side of the double-sided electrode, at an electric current flowing over a critical point, increased loads can be applied to the side of the double-sided electrode having a thinner thickness of an electrode active material layer. As a result, degradation of the electrode active material layer is accelerated on the thinner side, and eventually, the double-sided electrode becomes substantially a single-sided electrode, thus further increasing the rate of degradation of the battery.

In contrast, when each side of the double-sided electrode has a different material, degradation of the double-sided electrode can be suppressed or reduced. For example, an electrode active material layer enabling high output, positioned on a first side of the double-sided electrode, may carry the burden of providing the majority of high electric currents at high outputs, and an electrode active material layer positioned on a second side of the double-sided electrode may carry the burden of providing the rest of high electric currents. Accordingly, a load applied to the electrode active material layer on the second side of the double-sided electrodes may decrease.

Although a discharge capacity of an electrode active material layer in a double-sided electrode having a different material on each side may be lower than the discharge capacity of an electrode active material layer in a double-sided electrode having the same material on both sides, the electrode active material layer in a double-sided electrode having a different material on each side may have higher output characteristics. Moreover, higher output characteristics and lifetime characteristics of the battery may play a significant role when an output of the battery changes rapidly in real-time (for example, when a car using the battery as a power source is accelerated and decelerated (break or stop) at irregular intervals).

The first cathode active material layer in the lithium battery may include an ionically polarizable electrode material. In some embodiments, only the first cathode active material layer in the lithium battery may include an ionically polarizable electrode material. When the ionically polarizable electrode material is included in the first cathode active material layer, the first cathode active material layer may have an increased contact surface with an electrolytic solution, thereby improving high-rate characteristics of the lithium battery.

The ionically polarizable electrode material may be included (or be present) in an amount of about 0.1 wt % to about 40 wt % based on the total weight of the cathode active material and the ionically polarizable electrode material in the cathode active material layer. In embodiments where both the first cathode active material layer and the second cathode active material layer of the lithium battery include the ionically polarizable electrode material, the ionically polarizable electrode material may be included (or be present) in an amount of about 0.1 wt % to about 40 wt % based on the total weight of the first cathode active material, the second cathode active material, and the ionically polarizable electrode material. In embodiments where only the first cathode active material layer of the lithium battery includes the ionically polarizable electrode material, the ionically polarizable electrode material may be included (or be present) in an amount of about 0.1 wt % to about 40 wt % based on the total weight of the first cathode active material and the ionically polarizable electrode material. When the amount of the ionically polarizable electrode material is less than about 0.1 wt %, the ionically polarizable electrode material may be unable to achieve the desired effect, and when the amount of the ionically polarizable electrode material is more than about 40 wt %, capacity of the lithium battery may be significantly reduced.

In some embodiments, the ionically polarizable electrode material may be included (or be present) in an amount of about 0.5 wt % to about 30 wt % based on the total weight of the cathode active material and the ionically polarizable electrode material included in the cathode active material layer. In some embodiments, the ionically polarizable electrode material may be included in an amount of about 0.5 wt % to about 25 wt % based on the total weight of the cathode active material and the ionically polarizable electrode material included in the cathode active material layer.

In some embodiments, the ionically polarizable electrode material may be a porous carbonaceous material. The porous carbonaceous material may have a specific surface area of about 100 m²/g or greater. When the porous carbonaceous material has a specific surface area of less than 100 m²/g, an area of contact between the porous carbonaceous material and the electrolytic solution may decrease, and thus the high-rate characteristics of the lithium battery may also decrease. In some embodiments, the porous carbonaceous material may have a specific surface area of about 300 m²/g to about 3,500 m²/g. When the porous carbonaceous material has an excessively large specific surface area (e.g., when the specific surface area of the porous carbonaceous material exceeds 3,500 m²/g), the extent to which the porous carbonaceous material may enter into a side reaction with the electrolytic solution increases, thus resulting in a decrease of lifetime characteristics of the lithium battery. In some embodiments, the porous carbonaceous material may be activated carbon having a specific surface area of about 300 m²/g to about 3,000 m²/g.

The ionically polarizable electrode material in the lithium battery may have a different particle diameter than that of the cathode active material. Herein, the particle diameter may refer to an average particle diameter of secondary particles (D₅₀).

In some embodiments, the ionically polarizable electrode material may include particles having a small diameter, and the cathode active material may include particles having a large diameter. When the particle diameter of the ionically polarizable electrode material is smaller than that of the cathode active material, the ionically polarizable electrode material particles may fit into the pores between cathode active material particles, or may be coated on the surfaces of the cathode active material particles, thus resulting in a further increase in the concentration of lithium ions in the vicinity of the cathode active material. As a result, degradation of the lithium battery may be suppressed or reduced.

In some embodiments, the ionically polarizable electrode material located around the cathode active material particles may generally be porous. Therefore, before the lithium ions are intercalated/deintercalated by the cathode active material, a substantial amount of the lithium ions is adsorbed/desorbed by the porous ionically polarizable material having a relatively large surface. As a result, the concentration of the lithium ions around the cathode active material can be increased, and a prompt transfer of the lithium ions to the active material can be facilitated. In addition, the porous ionically polarizable material is in contact with the electrolytic solution including lithium salts, and accordingly, a high lithium ion concentration may be maintained around the cathode active material, and a reduced interfacial resistance atmosphere around the surface of the cathode active material may be provided.

In some embodiments, the ionically polarizable material may include particles having a large diameter, and the cathode active material may include particles having a small diameter. When the particle diameter of the ionically polarizable material is larger than that of the cathode active material, the cathode active material may be dispersed more uniformly, thus resulting in an electrode active material layer having a substantially uniform composition. In contrast, when the cathode active material is not uniformly dispersed, intercalation/deintercalation of lithium ions can be delayed during a high-rate charge/discharge process. As a result, lithium can be accumulated on the surface of an anode active material and/or a voltage of the cathode can be instantaneously increased, thereby causing a decomposition of the electrolytic solution.

In some embodiments, the ionically polarizable electrode material may have a bimodal particle diameter distribution that may be illustrated as having two peaks in a particle diameter distribution diagram. When the ionically polarizable electrode material has a bimodal particle diameter distribution, the ionically polarizable electrode material particles having a large diameter may improve dispersibility of the cathode active material particles.

Non-limiting examples of the ionically polarizable electrode material that can be utilized in the lithium battery may include one or more selected from an activated carbon, a nanofibrous carbon-coated activated carbon, a carbide derived carbon (CDC), a carbon nanotube (CNT), a carbon nanofiber (CNF), and a carbon black. However, the ionically polarizable electrode material is not limited to the above examples, and may include any suitable material that can be used as the ionically polarizable electrode material in lithium batteries. In some embodiments, the ionically polarizable electrode material may include a combination of the above-described materials. As used herein, the ionically polarizable electrode material refers to an electrode material in which ions can be physically adsorbed/desorbed onto the surface of the electrode material (e.g., a non-faradaic reaction of accumulating or emitting electric charges through adsorption/desorption of ions).

In some embodiments, the ionically polarizable electrode material includes a fibrous carbon-coated activated carbon material, in which an activated carbon may be coated with a fibrous carbon material (e.g., a carbon nanotube) having a larger specific surface area than that of the activated carbon. Accordingly, the concentration of lithium ions in the electrode active material layer may be increased during the charge/discharge process. In addition, since the fibrous carbon may act as a conducting path, electrical conductivity of the electrode can be improved.

The first anode active material of the lithium battery may include an amorphous carbon or a low crystalline carbon. When the first anode active material includes the amorphous carbon or the low crystalline carbon, a lithium battery having a high output density can be provided. In some embodiments, the first anode active material may include one or more selected from a soft carbon and a hard carbon.

The second anode active material in the lithium battery may include one or more selected from a high crystalline carbon, a metal alloyable (e.g., capable of forming an alloy) with lithium, and a metal oxide alloyable (e.g., capable of forming an alloy) with lithium. Lithium battery including the second anode active material of embodiments of the present invention may have a high energy density and a high discharge capacity.

The high crystalline carbon may include one or more selected from a natural graphite, an artificial graphite, a mesophase pitch carbide, and a calcined coke.

The first anode active material may be included (or be present) in an amount of about 10 wt % or greater based on the total weight of the first anode active material and the second anode active material. In some embodiments, the first anode active material may be included in an amount of about 10 wt % to about 90 wt % based on the total weight of the first anode active material and the second anode active material, for example, about 30 wt % to about 90 wt %, about 40 wt % to about 90 wt %, or about 50 wt % to about 90 wt %, based on the total weight of the first anode active material and the second anode active material.

The lithium battery may have a structure in which the first cathode active material layer and the first anode active material layer each contact the separator. In other words, the first cathode active material layer and the first anode active material layer may be opposite to face each other, with the separator therebetween. The cathode current collector and the anode current collector may be positioned respectively on the first cathode active material layer and the first anode active material layer, and the second cathode active material layer and the second anode active material layer may be positioned respectively on the cathode current collector and the anode current collector.

When the lithium battery has the structure in which the first cathode active material layer and the first anode active material layer each contact the separator, the lithium battery may have improved output characteristics.

The first cathode active material layer may have about 90% or less of an energy density of the second cathode active material layer (e.g., if the energy density of the second cathode active material layer is “×”, the energy density of the first cathode active material layer is “0.9×” or less). In other words, the first cathode active material layer may have about 90% or less of a discharge capacity of the second cathode active material layer, and the resulting lithium battery may have improved high output characteristics. In some embodiments, to improve the high output characteristics of the battery, a thickness of a cathode active material layer for high output may be thinner than a thickness of a cathode active material layer for a high capacity. Accordingly, a discharge capacity of the cathode active material layer having a high output may be about 90% or less of a discharge capacity of the cathode active material layer for high capacity.

In some embodiments, the first anode active material layer in the lithium battery may have about 90% or less of an energy density of the second anode active material layer. In other words, the first anode active material layer may have about 90% or less of a discharge capacity of the second anode active material layer, and the resulting lithium battery may have improved output characteristics. In some embodiments, to improve the high output characteristics of the battery, a thickness of an anode active material layer for high output may be thinner than a thickness of an anode active material layer for a high capacity. Accordingly, a discharge capacity of the anode active material layer having a high output may be about 90% or less of a discharge capacity of the anode active material layer for high capacity.

The first cathode active material and the second cathode active material in the lithium battery may each independently include one or more compounds represented by the following Formulae 1 to 5:

LiₓCo_{1-y}M_{y}O_{2-α}X_{αFormula} 1

LiₓNi_{y}Co_{z}M_{1-y-z}O₂₋₆₀ X_{α} Formula 2

LiₓMn₂₋ᵣMᵣO_{4-α}X_{α} Formula 3

LiₓCO₂₋ᵣMᵣO_{4-α}X_{α} Formula 4

LiₓMe_{y}M_{z}PO_{4-α}X_{α}. Formula 5

In Formulae 1 to 5, 0.90≦x≦1.1, 0≦y<1, 0≦z<1, 1-y-z>0, 0≦α≦2 and 0≦r<1, Me is one or more metals selected from titanium (Ti), vanadium (V), chromium (Cr), manganese (Mn), iron (Fe), cobalt (Co), nickel (Ni), copper (Cu), aluminum (Al), magnesium (Mg), zirconium (Zr) and boron (B), M is at least one element selected from magnesium (Mg), calcium (Ca), strontium (Sr), barium (Ba), titanium (Ti), zirconium (Zr), niobium (Nb), molybdenum (Mo), tungsten (W), zinc (Zn), aluminum (Al), silicon (Si), nickel (Ni), manganese (Mn), chromium (Cr), iron (Fe), magnesium (Mg), vanadium (V) and rare earth elements, and X is an element selected from oxygen (0), fluorine (F), sulfur (S) and phosphorous (P).

In the lithium battery, the first cathode active material and the second cathode active material may each independently include one or more compounds represented by the following Formulae 6 and 7:

Li[LiₐMe₁₋ₐ]O_{2+d} Formula 6

Li[Li_{b}Me_{c}M′ₑ]O_{2+d}. Formula 7

In Formulae 6 to 7, 0<a<1, b+c+e=1; 0<b<1, 0<e<0.1; 0≦d≦0.1, Me is one or more metals selected from titanium (Ti), vanadium (V), chromium (Cr), manganese (Mn), iron (Fe), cobalt (Co), nickel (Ni), copper (Cu), aluminum (Al), magnesium (Mg), zirconium (Zr) and boron (B), and M′ is one or more metals selected from molybdenum (Mo), tungsten (W), iridium (Ir), nickel (Ni) and magnesium (Mg).

In some embodiments, the first cathode active material and the second cathode active material in the lithium battery may include one or more compounds represented by the following Formulae 8 and 9:

pLi₂MO₃₋₍₁₋ₚ₎LiMeO₂ Formula 8

xLi₂MO_{3-y}LiMeO_{2-z}Li_{1+d}M′_{2-d}O₄. Formula 9

In Formulae 8 to 9, 0<p<1, x+y+z=1; 0<x<1, 0<y<1, 0≦d≦0.33; M is at least one selected from magnesium (Mg), calcium (Ca), strontium (Sr), barium (Ba), titanium (Ti), zirconium (Zr), niobium (Nb), molybdenum (Mo), tungsten (W), zinc (Zn), aluminum (Al), silicon (Si), nickel (Ni), manganese (Mn), chromium (Cr), iron (Fe), magnesium (Mg), vanadium (V) and rare earth elements, Me is one or more metals selected from titanium (Ti), vanadium (V), chromium (Cr), manganese (Mn), iron (Fe), cobalt (Co), nickel (Ni), copper (Cu), aluminum (Al), magnesium (Mg), zirconium (Zr) and boron (B), and M′ is one or more metals selected from titanium (Ti), vanadium (V), chromium (Cr), manganese (Mn), iron (Fe), cobalt (Co), nickel (Ni), copper (Cu), aluminum (Al), magnesium (Mg), zirconium (Zr) and boron (B).

In some embodiments, the lithium battery may include: a cathode, an anode, and a separator between the cathode and the anode. The cathode may include a first cathode active material layer including a lithium transition metal oxide on one side of a cathode current collector and a second cathode active material layer including a lithium transition metal oxide on the other side of the cathode current collector. The anode may include a first anode active material layer including an amorphous carbon or a low crystalline carbon on one side of an anode current collector and a second anode active material layer including a high crystalline carbon on the other side of the anode current collector. The first cathode active material layer may include an ionically polarizable electrode material. The first anode active material layer and the first cathode active material layer may provide improved output characteristics of the lithium battery, the second anode active material layer and the second cathode active material layer may provide improved discharge capacity of the lithium battery, and the ionically polarizable electrode material may provide improved lifetime characteristics of the lithium battery.

In some embodiments, the lithium battery may be manufactured as follows.

First, a cathode is prepared.

For example, the cathode may be manufactured as follows.

A first cathode active material, an ionically polarizable electrode material, a binder, a conducting agent and water are mixed to prepare a first cathode active material composition. The first cathode active material composition is directly coated on an aluminum current collector and dried to manufacture a positive electrode plate on which a first cathode active material layer is formed. Alternatively, the first cathode active material composition may be coated onto a separate supporting structure, a film may be then obtained by delaminating the first cathode active material composition from the supporting structure, and the obtained film may then be laminated onto the aluminum current collector to manufacture the positive electrode plate on which the first cathode active material layer is formed. However, the method for manufacturing the cathode is not limited to the above-listed embodiments.

A second cathode active material layer may be formed on the other side of the positive electrode plate, opposite from the side on which the first cathode active material layer is formed, by a method of manufacturing a second cathode active material layer that is the same or substantially the same as the method for manufacturing the first cathode active material layer. The second cathode active material layer may optionally include an ionically polarizable material. The first cathode active material and the second cathode active material may be the same as or different from each other.

In some embodiments, the cathode may include cathode active materials represented by any of the above-described Formulae 1 to 9 as the first cathode active material and/or the second cathode active material. In addition, the cathode may include additional cathode active materials, which may be known in the art of lithium batteries and which may have one or more differences in compositions, particle diameters and physical properties (e.g., specific surface area) as compared to the cathode active materials represented by the Formulae 1 to 9.

Examples of the additional cathode active materials may include lithium cobalt oxide, lithium nickel manganese cobalt oxide, lithium nickel cobalt aluminum oxide, lithium iron phosphate oxide, lithium manganese oxide, and combinations thereof. However, the additional cathode active materials are not limited to the listed examples, and may include any suitable cathode active materials that can be used in lithium batteries.

For example, the additional cathode active materials may include compounds represented by formulae including: LiₐA_{1-b}B_{b}D₂, where 0.90≦a≦1.8 and 0≦b≦0.5; LiₐE_{1-b}B_{b}O_{2-c}D_{c}, where 0.90≦a≦1.8, 0≦b≦0.5 and 0≦c≦0.05; LiE_{2-b}B_{b}O_{4-c}D_{c}, where 0≦b≦0.5 and 0≦c≦0.05; LiₐNi_{1-b-c}Co_{b}B_{c}D_{α}, where 0.90≦a≦1.8, 0≦c≦0.05 and 0<α≦2; LiₐNi_{1-b-c}Co_{b}B_{c}O_{2-α}F_{α, where} 0.90≦a≦1.8, 0≦b≦0.5, 0≦c≦0.05 and 0<α<2; LiₐNi_{1-b-c}Co_{b}B_{c}O_{2-α}F₂, where 0.90≦a≦1.8, 0≦b≦0.5, 0≦c≦0.05 and 0<α<2; LiₐNi_{1-b-c}Mn_{b}B_{c}Dₐ, where 0.90≦a≦1.8, 0≦b≦0.5, 0≦c≦0.05 and 0<α≦2; LiₐNi_{1-b-c}Mn_{b}B_{c}O_{2-α}F_{α}, where 0.90≦a≦1.8, 0≦b≦0.5, 0≦c≦0.05 and 0<α<2; LiₐNi_{1-b-c}Mn_{b}B_{c}O_{2-α}F₂, where 0.90≦a≦1.8, 0≦b≦0.5, 0≦c≦0.05 and 0<α<2; LiₐNi_{b}E_{c}G_{d}O₂, where 0.90≦a≦1.8, 0≦b≦0.9, 0≦c≦0.5 and 0.001≦d≦0.1; LiₐNi_{b}Co_{c}Mn_{d}GₑO₂, where 0.90≦a≦1.8, 0≦b≦9.0, 0≦c≦0.5, 0≦d≦0.5 and 0.001≦e≦0.1; LiₐNiG_{b}O₂, where 0.90≦a≦1.8 and 0.001≦b≦0.1; LiₐCoG_{b}O₂, where 0.90≦a≦1.8 and 0.001≦b≦0.1; LiₐMnG_{b}O₂, where 0.90≦a≦1.8 and 0.001≦b≦0.1; LiₐMn₂G_{b}O₄, where 0.90≦a≦1.8 and 0.001≦b≦0.1; QO₂; QS₂; LiQS₂; V₂O₅; LiV₂O₅; LiIO₂; LiNiVO₄; Li_{(3-f)}J₂(PO₄)₃, where 2≦f≦2; Li_{(3-f)}Fe₂(PO₄)₃, where 0≦f≦2; and LiFePO₄.

In the above formulae, A is Ni, Co, Mn or a combination thereof, B is Al, Ni, Co, Mn, Cr, Fe, Mg, Sr, V, a rare earth element or a combination thereof, D is O, F, S, P or a combination thereof, E is Co, Mn or a combination thereof, F is F, S, P or a combination thereof, G is Al, Cr, Mn, Fe, Mg, La, Ce, Sr, V or a combination thereof, Q is Ti, Mo, Mn or a combination thereof, I is Cr, V, Fe, Sc, Y or a combination thereof, and J is V, Cr, Mn, Co, Ni, Cu or a combination thereof.

In some embodiments, some of the additional cathode active materials may have a coating layer formed on their surfaces, and the cathode may include a mixture of the additional cathode active materials without a coating layer and the additional cathode active materials with the coating layer.

The coating layers for the other cathode active materials may include coating element compounds such as, for example, coating element oxides, coating element hydroxides, coating element oxyhydroxides, coating element oxycarbonates or coating element hydroxycarbonates. Compounds for forming the coating layers may be amorphous or crystalline. Non-limiting examples of the coating element may include magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), barium (B), arsenic (As), zirconium (Zr), and mixtures thereof. Any suitable coating method may be used to form the coating layer, so long as it does not adversely affect physical properties of the cathode active materials. For example, a spray coating method, a dipping method, or the like may be used. Since the coating methods should be apparent to those of ordinary skill in the art, a detailed description on the coating methods is not provided herein.

In some embodiments, the first cathode active material and the second active material may each independently include LiNiO₂, LiCoO₂, LiMnₓO₂ₓ(x=1, 2), LiNi₁₋ₓMnₓO₂ (0<x<1), LiNi_{1-x-y}CoₓMn_{y}O₂ (0≦f≦0.5, 0≦y≦0.5), LiFeO₂, V₂O₅, TiS, MoS, or the like.

Examples of the conducting agent may include: carbon blacks; graphite particles; natural graphites; artificial graphites; acetylene blacks; ketjen blacks; carbon fibers; carbon nanotubes; metal powders, metal fibers or metal tubes of copper, nickel, aluminum, silver, or the like; and conducting polymers such as, for example, polypenylene derivatives. However, the conducting agent is not limited to these examples, and may include any suitable materials that can be used in lithium batteries.

Non-limiting examples of the binder may include vinylidene fluoride/hexafluoropropylene copolymers, polyvinylidene fluoride, polyacrylonitrile, polymethyl methacrylate, polytetrafluoroethylene (PTFE), mixtures of the above-described polymers, styrene butadiene rubber based polymers, and the like.

Examples of the solvent may include N-methylpyrrolidone (NMP), acetone, water, and the like. However, the solvent is not limited to the above examples, and may include any suitable material that can be used in lithium batteries.

The cathode active material, the conducting agent, the water-based binder and the solvent may each be included (or be present) in amounts that are suitable for use in a lithium battery. In some embodiments, one or more of the conducting agent, the binder and the solvent may be omitted, according to uses and compositions of the lithium battery.

In some embodiments, a first anode active material, a conducting agent, a binder and a solvent are mixed to prepare a first anode active material composition. The first anode active material composition may be directly coated and then dried on a metal current collector to manufacture a negative electrode plate. Alternatively, the first anode active material composition may be coated onto a separate supporting structure, a film may be obtained by delaminating the anode active material composition from the supporting structure, and the obtained film may then be laminated onto the metal current collector to manufacture the negative electrode plate. However, the method for manufacturing the anode is not limited to the above-listed embodiments.

A second anode active material layer may be formed on the other side of the negative electrode plate, opposite from the side on which the first anode active material layer is formed, by a method of manufacturing the second anode active material layer that is the same or substantially the same as the method for manufacturing the first anode active material layer.

In some embodiments, the first anode active material may include an amorphous carbon or a low crystalline carbon. For example, the first anode active material may be a soft carbon (e.g., a low temperature calcined carbon) or a hard carbon. The hard carbon may be prepared from sucrose, phenolic resin, naphthalene resin, polyvinyl alcohol resin, furfuryl alcohol resin, polyacrylonitrile resin, polyamide resin, furan resin, cellulose resin, styrene resin, polyimide resin, epoxy resin, or vinyl chloride resin. The soft carbon may be prepared from coal based pitch, petroleum based pitch, polyvinyl chloride, mesophase pitch, tar, or low molecular weight heavy oil.

In some embodiments, the second anode active material may include one or more selected from a high crystalline carbon, a metal alloyable with lithium, and a metal oxide alloyable with lithium.

Non-limiting examples of the crystalline carbon may include shapeless, plate-shaped, flake-shaped, spherical or fibrous natural graphites or artificial graphites, mesophase pitch carbides, and calcined cokes.

Non-limiting examples of the metal alloyable with lithium may include: Si, Sn, Al, Ge, Pb, Bi, Sb and Si—Y alloys (where Y is an alkali metal, an alkali earth metal, a Group 13 element, a Group 14 element, a transition metal, a rare earth atom or a combination thereof, and Y is not Si); and Sn—Y alloys (where Y is an alkali metal, an alkali earth metal, a Group 13 element, a Group 14 element, a transition metal, a rare earth atom or a combination thereof, and Y is not Sn). Non-limiting examples of Y may include Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, and combinations thereof.

Non-limiting examples of the metal oxide alloyable with lithium may include oxides of transition metals such as a lithium titanium oxide, a vanadium oxide and a lithium vanadium oxide, and oxides of non-transition metals such as SnO₂ and SiOₓ (where 0<x<2).

For example, the second anode active material may include one or more selected from graphite, Si, Sn, Pb, Ge, Al, SiOₓ (where 0<x≦2), SnO_{y} (where 0<y≦2), Li₄Ti₅O₁₂, TiO₂, LiTiO₃, and Li₂Ti₃O₇.

Non-limiting examples of the binder may include vinylidene fluoride/hexafluoropropylene copolymers, polyvinylidene fluoride, polyacrylonitrile, polymethyl methacrylate, polytetrafluoroethylene (PTFE), mixtures of the above-described polymers, styrene butadiene rubber based polymers, a first conductive water-based binder, and mixtures thereof.

In some embodiments, the anode active material composition and the cathode active material composition may include the same conducting agent and solvent. In some embodiments, a plasticizer may be additionally included into the cathode active material composition and/or the anode active material composition, and may enable the formation of pores in an electrode plate.

The anode active material, the conducting agent, the binder and the solvent may each be included (or be present) in an amount suitable for use in a lithium battery.

In some embodiments, one or more of the conducting agent, the binder and the solvent may be omitted, according to uses and compositions of the lithium battery.

A separator may be inserted between the cathode and the anode. The separator may be any suitable separator commonly used in lithium batteries. The separator may have a low resistance to migration of ions in an electrolyte and an excellent electrolyte-retaining ability. In some embodiments, the separator may be a glass fiber separator, a polyester separator, a Teflon separator, a polyethylene separator, a polypropylene separator, a polytetrafluoroethylene (PTFE) separator or a combination thereof, and may be a non-woven fabric or a woven fabric separator. For example, a rollable separator such as a polyethylene or a polypropylene separator may be used for a lithium ion battery. In some embodiments, a separator included in a lithium ion polymer battery may have an excellent organic electrolytic solution-retaining capability. The separator may be manufactured according to the following method.

A polymer resin, a filler and a solvent may be mixed together to prepare a separator composition. The separator composition may be directly coated onto an electrode and then dried to form the separator. Alternatively, the separator composition may be coated onto a separate supporting structure, dried to form a separator film, and the resulting film may then be separated from the supporting structure and laminated onto the electrode to form the separator.

The polymer resin used to manufacture the separator may be any suitable material that can be used as a binder for electrode plates. Non-limiting examples of the polymer resin may include vinylidene fluoride/hexafluoropropylene copolymers, polyvinylidene fluoride (PVDF), polyacrylonitrile, polymethyl methacrylate, and mixtures thereof.

Next, an electrolyte may be prepared.

The electrolyte may be an organic electrolytic solution, and in some embodiments, may be solid. Examples of the electrolyte may include boron oxides and lithium oxynitrides. but the electrolyte is not limited thereto, and may include any suitable solid electrolyte. The solid electrolyte may be formed on the anode by sputtering or the like.

In some embodiments, the organic electrolytic solution may be prepared by dissolving lithium salts in an organic solvent.

The organic solvent may be any suitable material that can be used as the organic solvent in lithium batteries. Non-limiting examples of the organic solvent may include propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, γ-butyrolactone, dioxolane, 4-methyldioxolane, N,N-dimethylformamide, dimethylacetamide, dimethylsulfoxide, dioxane, 1,2-dimethoxyethane, sulforane, dichloroethane, chlorobenzene, nitrobenzene, diethylene glycol, dimethylether, and mixtures thereof.

The lithium salt may be any suitable lithium salt and non-limiting examples thereof may include LIPF₆, LiBF₄, LiSbF₆, LiAsF₆, LiCIO₄, LiCF₃SO₃, Li(CF₃SO₂)₂N, LiC₄F₉SO₃, LiAlO₂, LiAlCl₄, LiN(CₓF₂ₓ₊₁, SO₂) (C_{y}F_{2y+1}SO₂) (where x and y are natural numbers), LiCl, LiI, and mixtures thereof.

As shown in the drawing, the lithium battery 1 includes a cathode 3, an anode 2, and a separator 4. The cathode 3, anode 2 and separator 4 may be wound or folded, and then may be inserted into a battery case 5. Subsequently, an organic electrolytic solution may be injected into the battery case 5, and the battery case 5 may then be sealed by a cap assembly 6, thus manufacturing the lithium battery 1. The cathode 3 may be a double-sided cathode in which a first cathode active material layer and a second cathode active material layer are respectively formed on both sides of a cathode current collector. Similarly, the anode 2 may be a double-sided anode in which a first anode active material layer and a second anode active material layer are respectively formed on both sides of an anode current collector. The battery case 5 may be a cylindrical battery case, a rectangular battery case, a thin-film type battery case, or a pouch type battery case, but the battery case 5 is not limited thereto. In some embodiments, the lithium battery 1 may be a thin-film type battery, and in some embodiments, may be a lithium ion battery.

In some embodiments, the lithium battery 1 may be a lithium ion polymer battery, and may be manufactured by placing the separator between the cathode and the anode to form a battery assembly, stacking the battery assembly into a bicell structure and impregnating it with an organic electrolytic solution, inserting the resulting assembly into a pouch, and sealing the pouch.

In some embodiments, a plurality of battery assemblies may be stacked (or connected) in series to form a battery pack, and such battery pack may be used in any device that requires high capacity and high output. For example, the battery pack may be used in notebooks, smart phones, electric vehicles, and the like.

The lithium battery of embodiments of the present invention may be suitable for use in electric vehicles (EVs), since it may be capable of providing improved discharge capacity, output characteristics, and lifetime characteristics. In some embodiments, the lithium battery may be used in hybrid vehicles (HVs) such as, for example, plug-in hybrid electric vehicles (PHEVs). The vehicles may include a battery model or a battery pack including a plurality of the lithium batteries.

In some embodiments, the above-described lithium battery may be included in an energy storage system (ESS). The ESS may include a battery model or a battery pack including a plurality of the lithium batteries.

Hereinafter, embodiments of the present invention are illustrated with reference to certain examples. However, these examples are provided for illustrative purposes only, and should not in any sense be interpreted as limiting the scope of the present disclosure.

### EXAMPLE 1

(Manufacturing a Cathode)

LiCoO₂ having an average particle diameter of about 5 μm, pitch based activated carbon produced by Kuraray Chemical Co., Ltd, acetylene black produced by Denki Kagaku Kogyo Kabushiki Kaisha, and polyvinylidene fluoride (PVdF) were mixed at a weight ratio of 80:10:5:5 to form a mixture, and the resulting mixture was mixed with N-methylpyrrolidone (NMP) in an agate mortar to prepare a first cathode active material slurry.

LiCoO₂ having an average particle diameter of about 5 μm, acetylene black produced by Denki Kagaku Kogyo Kabushiki Kaisha, and polyvinylidene fluoride (PVdF) were mixed at a weight ratio of 95:2:3 to form a mixture, and the resulting mixture was mixed with N-methylpyrrolidone (NMP) in an agate mortar to prepare a second cathode active material slurry.

The first cathode active material slurry was coated at a thickness of about 20 um on an aluminum current collector having a thickness of about 15 μm using a doctor blade, dried at room temperature, and then dried again under a vacuum atmosphere at 120° C., thus manufacturing a cathode plate having a first cathode active material layer formed on one side thereof.

A second cathode active material layer was formed on the other side of the cathode plate using the method for forming the first cathode active material layer, thus preparing a double-sided cathode.

(Manufacturing an Anode)

Amorphous carbon (soft carbon produced by Hitachi), acetylene black produced by Denki Kagaku Kogyo Kabushiki Kaisha, styrene-butadiene rubber (SBR) produced by Zeon Corporation, and carboxymethyl cellulose (CMC) produced by Nippon A&L Inc. were mixed at a weight ratio of 93:4:1.5:1.5 to form a mixture, and the resulting mixture was mixed with distilled water and stirred for about 60 minutes with a mechanical stirrer to prepare a first anode active material slurry.

Artificial graphite BSG-L produced by Tianjin BTR New Energy Technology Co., Ltd, SBR produced by Zeon Corporation, and CMC produced by Nippon A&L Inc. were mixed at a weight ratio of 98:1:1 to form a mixture, and the resulting mixture was mixed with distilled water, and stirred for about 60 minutes with a mechanical stirrer to prepare a second anode active slurry.

The first anode active material slurry was coated at a thickness of about 60 um on a copper current collector having a thickness of about 10 μm using a doctor blade, was dried by a hot air dryer of 100° C. for about 0.5 hour, and then was dried again under a vacuum atmosphere at 120° C. for about four hours, thus manufacturing an anode plate having a first anode active material layer formed on one side thereof.

A second anode active material layer was formed on the other side of the anode plate using the method for forming the first anode active material layer, thus preparing a double-sided anode.

(Manufacturing a Lithium battery)

A lithium battery having a structure of [a second cathode active material layer/a cathode current collector/a first cathode active material layer/a separator/a first anode active material layer/an anode current collector/a second anode active material layer] was manufactured using the cathode, the anode and a PE based separator V25CGD produced by ExxonMobil Chemical. The lithium battery was wound into a cylindrical form (or a jelly roll), and the jelly roll was placed inside an aluminum pouch.

An electrolyte was then injected into the aluminum pouch containing the jelly roll, and the aluminum pouch was sealed, thus manufacturing a 200 mAh grade battery. The electrolyte was a solution including 1.5M of LiPF₆ dissolved in a solvent including a mixture of ethylene carbonate (EC), dimethyl carbonate (DMC), and diethyl carbonate (DEC) (at a volume ratio of 3:3:4).

### EXAMPLE 2

A lithium battery was manufactured as in Example 1 except that a weight ratio of LiCoO₂ having an average particle diameter of about 5 μm, pitch based activated carbon produced by Kuraray Chemical Co., Ltd, acetylene black produced by Denki Kagaku Kogyo, and polyvinylidene fluoride (PVdF) in the first cathode active material layer was 87:3:5:5.

### EXAMPLE 3

A lithium battery was manufactured as in Example 1 except that a weight ratio of LiCoO₂ having an average particle diameter of about 5 μm, pitch based activated carbon produced by Kuraray Chemical Co., Ltd, acetylene black produced by Denki Kagaku Kogyo, and polyvinylidene fluoride (PVdF) in the first cathode active material layer was 85:5:5:5.

### EXAMPLE 4

A lithium battery was manufactured as in Example 1 except that a weight ratio of LiCoO₂ having an average particle diameter of about 5 μm, pitch based activated carbon produced by Kuraray Chemical Co., Ltd, acetylene black produced by Denki Kagaku Kogyo, and polyvinylidene fluoride (PVdF) in the first cathode active material layer was 70:20:5:5.

### EXAMPLE 5

A lithium battery was manufactured as in Example 1 except that a weight ratio of LiCoO₂ having an average particle diameter of about 5 μm, pitch based activated carbon produced by Kuraray Chemical Co., Ltd, acetylene black produced by Denki Kagaku Kogyo, and polyvinylidene fluoride (PVdF) in the first cathode active material layer was 60:30:5:5.

### COMPARATIVE EXAMPLE 1

A lithium battery was manufactured as in Example 1 except that the first cathode active material layer composition included a mixture of LiCoO₂ having an average particle diameter of about 5 um, acetylene black produced by Denki Kagaku Kogyo, and polyvinylidene fluoride (PVdF) at a weight ratio of 90:5:5.

### COMPARATIVE EXAMPLE 2

A lithium battery was manufactured as in Example 1 except that the first cathode active material layer composition included a mixture of LiCoO₂ having an average particle diameter of about 5 um, pitch based activated carbon produced by Kuraray Chemical Co., Ltd, acetylene black produced by Denki Kagaku Kogyo, and polyvinylidene fluoride (PVdF) at a weight ratio of 55:35:5:5.

### COMPARATIVE EXAMPLE 3

A lithium battery was manufactured as in Example 1 except that the first cathode active material layer composition included a mixture of pitch based activated carbon produced by Kuraray Chemical Co., Ltd, acetylene black produced by Denki Kagaku Kogyo, and polyvinylidene fluoride (PVdF) at a weight ratio of 90:5:5.

### COMPARATIVE EXAMPLE 4

A lithium battery was manufactured as in Example 1 except that the first cathode active material layer composition included a mixture of pitch based activated carbon produced by Kuraray Chemical Co., Ltd, acetylene black produced by Denki Kagaku Kogyo, and polyvinylidene fluoride (PVdF) at a weight ratio of 90:5:5, and the first anode active material layer and the second anode active material layer had the same composition.

### COMPARATIVE EXAMPLE 5

A lithium battery was manufactured as in Example 1 except that the first cathode active material layer composition included a mixture of pitch based activated carbon produced by Kuraray Chemical Co., Ltd, acetylene black produced by Denki

Kagaku Kogyo, and polyvinylidene fluoride (PVdF) at a weight ratio of 90:5:5, and the first anode active material layer composition included a mixture of pitch based activated carbon produced by Kuraray Chemical Co., Ltd, acetylene black produced by Denki Kagaku Kogyo, SBR produced by Zeon Corporation, and CMC produced by Nippon A&L at a weight ratio of 93:4:1.5:1.5.

### EVALUATION EXAMPLE 1

### Evaluation of Charge/Discharqe Characteristics

The pouch cells manufactured in Examples 1 to 5 and Comparative Examples 1 to 5 were each charged at a constant current at 0.2C rate and at a temperature of about 25° C. until a voltage of the cell reached about 4.2 V (vs. Li).

Subsequently, each cell was discharged at a constant current at about 0.2C rate until a voltage of the cell reached about 2.0 V during the discharge as one cycle. The charge and discharge cycles were repeated twice for each cell in the formation process.

After conducting the formation process, the pouch cells manufactured in Examples 1 to 5 and Comparative Examples 1 to 5 were each charged at a constant current at 0.2C rate and at a temperature of about 25° C. until the voltage of the cell reached about 4.2 V. Subsequently, each cell was discharged at a constant current at about 0.2C rate until the voltage of the cell reached about 2.0 V during the discharge in a first cycle.

After the first cycle was completed, the pouch cells manufactured in Examples 1 to 5 and Comparative Examples 1 to 5 were each charged at a constant current charge at 4.0 C rate until the voltage of the cell reached about 4.2 V.

Subsequently, each cell was discharged at a constant current at about 4.0 C rate until the voltage of the cell reached about 2.0 V during the discharge. The charge-discharge cycle was repeated 300 times for each cell. Test results are shown in the following Table 1.

A discharge capacity of the cell at the first cycle was defined as an initial capacity. A capacity retention of the cell was calculated using the following equation 1. A 0.2C capacity is a discharge capacity at the first cycle.

4C capacity retention[%]=[discharge capacity at 300th cycle/discharge capacity at 1st cycle]×100 Equation 1

### EVALUATION EXAMPLE 2

### Evaluation of High-Rate Characteristics

The pouch cells manufactured in Examples 1 to 5 and Comparative Examples 1 to 5 were each charged at a constant current at 0.2 C rate and at a temperature of about 25° C. until the voltage of the cell reached about 4.2 V (vs. Li). Subsequently, each cell was discharged at a constant current at about 0.2 C rate until the voltage of the cell reached about 2.0 V during the discharge as one cycle. The charge and discharge cycles were repeated twice for each cell in the formation process.

After conducting the formation process, the pouch cells manufactured in

Examples 1 to 5 and Comparative Examples 1 to 5 were each charged at a constant current at 0.2 C rate and at a temperature of about 25° C. until the voltage of the cell reached about 4.2 V. Subsequently, each cell was discharged at a constant current at about 0.2 C rate until the voltage of the cell reached about 2.0 V during the discharge (a first cycle).

After the first cycle, the pouch cells manufactured in Examples 1 to 5 and

Comparative Examples 1 to 5 were each charged at a constant current charge at 1.0C rate until a voltage reached about 4.2 V. Subsequently, each cell was discharged at a constant current at about 5.0C rate until a voltage reached about 2.0 V during the discharge (a second cycle).

After the second cycle, the pouch cells manufactured in Examples 1 to 5 and Comparative Examples 1 to 5 were each charged at a constant current charge at 1.0C rate until a voltage reached about 4.2 V. Subsequently, each cell was discharged at a constant current at about 10.0 C rate until a voltage reached about 2.0 V during the discharge to measure high rate characteristics (a third cycle).

Measurement results are shown in the following Table 1. High-rate characteristics were calculated using the following Equations 2 and 3.

5 C/1 C capacity retention[%]=[a discharge capacity (5 C) in the second cycle/a discharge capacity (1 C) in the first cycle]×100 Equation 2

10C/1C capacity retention[%]=[a discharge capacity (10 C) in the third cycle/a discharge capacity (1 C) in the first cycle]×100 Equation 3

TABLE 1

| | | | | 4 C |
|---|---|---|---|---|
| | 0.2 C | 5 C/1 C | 10 C/1 C | capacity |
| | capacity | capacity | capacity | retention [%] |
| | [mAh] | retention [%] | retention [%] | after 300 cycles |
| Example 1 | 195 | 96.7 | 89.4 | 86.7 |
| Example 2 | 209 | 94.6 | 87.5 | 85.5 |
| Example 3 | 203 | 96.5 | 89.8 | 86.5 |
| Example 4 | 176 | 96.4 | 90.1 | 86.0 |
| Example 5 | 154 | 97.1 | 90.6 | 85.4 |
| Comparative | 223 | 86.8 | 72.0 | 54 |
| Example 1 | | | | |
| Comparative | 127 | 96.9 | 91.1 | 83.1 |
| Example 2 | | | | |
| Comparative | 109 | 98.6 | 87.4 | 72.1 |
| Example 3 | | | | |
| Comparative | 122 | 85.2 | 70.1 | 73.1 |
| Example 4 | | | | |
| Comparative | 62 | 98.9 | 95.2 | 95.0 |
| Example 5 | | | | |

As can be seen from Table 1, the lithium batteries of Examples 1 to 5 showed improved high-rate characteristics, discharge capacities, and lifetime characteristics at high rates, at least in part due to the appropriate distribution of the applied high currents.

In contrast, the lithium battery of Comparative Example 1 had high discharge capacity, but showed very poor lifetime characteristics at a high rate. The lithium battery of Comparative Example 2 had excellent high-rate characteristics, but showed very poor discharge capacity. The lithium batteries of Comparative Examples 3 and 4 showed relatively poor discharge capacities and lifetime characteristics. The lithium battery of Comparative Example 5 had a significantly poor discharge capacity.

According to one or more embodiments of the present invention, a lithium battery including a double-sided cathode including an ionically polarizable electrode material may have improved discharge capacity, output characteristics, and lifetime characteristics.

It should be understood that the exemplary embodiments described herein should be considered in a descriptive sense only and not for purposes of limitation. Descriptions of features or aspects within each embodiment should typically be considered as available for other similar features or aspects in other embodiments.

While one or more embodiments of the present invention have been described with reference to the drawing, it will be understood by those of ordinary skill in the art that various changes in form and details may be made therein without departing from the spirit and scope of the present invention as defined by the following claims and equivalents thereof.

What is claimed is:

1. A lithium battery comprising:
a cathode, an anode, and a separator between the cathode and the anode,
wherein the cathode comprises a first cathode active material layer comprising a first cathode active material on a first side of a cathode current collector and a second cathode active material layer comprising a second cathode active material on a second side of the cathode current collector, opposite the first side,
wherein the anode comprises a first anode active material layer comprising a first anode active material on a first side of an anode current collector and a second anode active material layer comprising a second anode active material on a second side of the anode current collector, opposite the first side, and
wherein at least one of the first cathode active material layer and the second cathode active material layer comprises an ionically polarizable electrode material.

2. The lithium battery of claim 1, wherein the ionically polarizable electrode material is a porous carbonaceous material.

3. The lithium battery of claim 2, wherein the porous carbonaceous material has a specific surface area of about 100 m²/g or greater.

4. The lithium battery of claim 1, wherein the ionically polarizable electrode material comprises at least one selected from an activated carbon, a nanofibrous carbon-coated activated carbon, a carbide derived carbon (CDC), a carbon nanotube (CNT), a carbon nanofiber (CNF), and a carbon black.

5. The lithium battery of claim 1, wherein the first anode active material comprises an amorphous carbon or a low crystalline carbon.

6. The lithium battery of claim 1, wherein the second anode active material comprises at least one selected from a high crystalline carbon, a metal alloyable with lithium, and a metal oxide alloyable with lithium.

7. The lithium battery of claim 1, wherein the first anode active material is in an amount of about 10% by weight or greater based on the total weight of the first anode active material and the second anode active material.

8. The lithium battery of claim 1, wherein the first cathode active material layer and the first anode active material layer are in contact with the separator.

9. The lithium battery of claim 1, wherein energy density of the first cathode active material layer is less than or equal to about 90% of energy density of the second cathode active material layer.

10. The lithium battery of claim 1, wherein energy density of the first anode active material layer is less than or equal to about 90% of energy density of the second anode active material layer.

11. The lithium battery of claim 1, wherein the first cathode active material and the second cathode active material each independently comprise at least one compound represented by Formulae 1 to 9:
LiₓCo_{1-y}M_{y}O_{2-α}X_{αFormula} 1
LiₓNi_{y}Co_{z}M_{1-y-z}O₂₋₆₀ X_{α} Formula 2
LiₓMn₂₋ᵣMᵣO_{4-α}X_{α} Formula 3
LiₓCO₂₋ᵣMᵣO_{4-α}X_{α} Formula 4
LiₓMe_{y}M_{z}PO_{4-α}X_{α}, Formula 5
wherein, in Formulae 1 to 5, 0.90≦x≦1.1, 0<≦y≦1, 0≦z<1, 1-y-z>0, 0≦α≦2 and 0≦r<1, Me includes at least one metal selected from titanium (Ti), vanadium (V), chromium (Cr), manganese (Mn), iron (Fe), cobalt (Co), nickel (Ni), copper (Cu), aluminum (Al), magnesium (Mg), zirconium (Zr) and boron (B), M is at least one selected from magnesium (Mg), calcium (Ca), strontium (Sr), barium (Ba), titanium (Ti), zirconium (Zr), niobium (Nb), molybdenum (Mo), tungsten (W), zinc (Zn), aluminum (Al), silicon (Si), nickel (Ni), manganese (Mn), chromium (Cr), iron (Fe), magnesium (Mg), strontium (Sr), vanadium (V) and rare earth elements, and X is selected from oxygen (O), fluorine (F), sulfur (S) and phosphorous (P);
Li[LiₐMe₁₋ₐ]O_{2+d} Formula 6
Li[Li_{b}Me_{c}M′ₑ]O_{2+d}. Formula 7
wherein, in Formulae 6 and 7, 0<a<1, b+c+e=1; 0<b<1, 0<e<0.1; 0≦d≦0.1, Me includes at least one metal selected from titanium (Ti), vanadium (V), chromium (Cr), manganese (Mn), iron (Fe), cobalt (Co), nickel (Ni), copper (Cu), aluminum (Al), magnesium (Mg), zirconium (Zr) and boron (B), and M′ includes at least one metal selected from molybdenum (Mo), tungsten (W), iridium (Ir), nickel (Ni) and magnesium (Mg);
pLi₂MO₃-(1-p)LiMeO₂ Formula 8
xLi₂MO₃-yLiMeO₂-zLi_{1+d}M′_{2-d}O₄. Formula 9
wherein, in Formulae 8 and 9, 0<p<1, x+y+z=1; 0<x<1, 0<y<1, 0<z<1; 0≦d≦0.33, M is at least one selected from magnesium (Mg), calcium (Ca), strontium (Sr), barium (Ba), titanium (Ti), zirconium (Zr), niobium (Nb), molybdenum (Mo), tungsten (W), zinc (Zn), aluminum (Al), silicon (Si), nickel (Ni), manganese (Mn), chromium (Cr), iron (Fe), magnesium (Mg), strontium (Sr), vanadium (V) and rare earth elements, Me includes at least one metal selected from titanium (Ti), vanadium (V), chromium (Cr), manganese (Mn), iron (Fe), cobalt (Co), nickel (Ni), copper (Cu), aluminum (Al), magnesium (Mg), zirconium (Zr) and boron (B), and M′ includes at least one metal selected from titanium (Ti), vanadium (V), chromium (Cr), manganese (Mn), iron (Fe), cobalt (Co), nickel (Ni), copper (Cu), aluminum (Al), magnesium (Mg), zirconium (Zr) and boron (B).

12. The lithium battery of claim 1, wherein the first cathode active material is different from the second cathode active material.

13. A vehicle comprising the lithium battery according to claim 1.

14. An energy storage system comprising the lithium battery according to claim 1.
